(19) United States
(12) Patent Application Publication
(10) Pub. No.: US 2025/0330776 A1
(43) Pub. Date: Oct. 23, 2025

(54) Personal Item Tracking System and Method Therefor

(71) Applicants: Syed Saeedi, Irvine, CA (US); Nasreen Saeedi, Irvine, CA (US)

(72) Inventors: Syed Saeedi, Irvine, CA (US); Nasreen Saeedi, Irvine, CA (US)

(21) Appl. No.: 18/637,590

(22) Filed: Apr. 17, 2024

(51) Int. Cl. H04W 4/029; H04W 4/02

(52) U.S. Cl. CPC H04W 4/029; H04W 4/023

(57) ABSTRACT

A personal item tracking system includes a first location tracking structure, a second location tracking structure, and an electronic device. The first location tracking structure is engageable with a container for a personal item. The second location tracking structure is engageable to a personal item. The electronic device is wirelessly connected to the location tracking structures to monitor the locations thereof. The electronic device is designed to alert a user when the second location tracking structure is located beyond a threshold distance from the first location tracking structure to enable the user to find the personal item and minimize loss thereof.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

The disclosure relates to tracking systems and devices and more particularly pertains to a new personal item tracking system to allow a person to keep track of personal items, such as banking cards, identification cards, wallets, keys, eyeglasses, and other similar personal items of value in relation to a container in which such items are normally stored, such as a wallet, purse, pocketbook, travel bag, duffle bag, briefcase, valet, diaper bag, backpack, or any other such container that a person would regularly carry such items in.

### (2) Description of Related Art Including Information Disclosed Under 37 CFR 1.97 and 1.98

The prior art relates to tracking systems and devices. The prior art, as best understood, does not disclose personal item tracking system that includes a first location tracking structure for a container for personal items, a second location tracking structure for a personal item, and an electronic device, wherein the electronic device is wirelessly connected to the location tracking structures to monitor the locations thereof, and wherein the electronic device alerts a user when the second location tracking structure is located beyond a threshold distance from the first location tracking structure.

### BRIEF SUMMARY OF THE INVENTION

An embodiment of the disclosure meets the needs presented above in a personal item tracking system generally comprising a first location tracking structure, a second location tracking structure, and an electronic device. The first location tracking structure is engageable with a container for a personal item, such as a purse or wallet. The second location tracking structure is engageable to a personal item, such as a banking card or identification card. The electronic device is wirelessly connected to the location tracking structures to monitor the locations thereof. The electronic device is designed to alert a user when the second location tracking structure is located beyond a threshold distance from the first location tracking structure. In this manner, a user will be alerted if the personal item is no longer in the container. For example, if a person is at a restaurant, and he or she leaves behind a credit card at the table, when the person leaves and takes the container for the credit card, such as a purse or wallet, beyond the threshold distance, the electronic device, such as a smart phone or tablet having an app or computer program, alerts the person that the personal item—the credit card—is beyond the threshold distance away from its container—a purse or wallet. The person can then use the tracking information to find the credit card. Such a system would protect against loss of personal items, such as by a person accidentally leaving personal items behind after use, theft by other persons, and personal items accidentally falling out or otherwise being dislodged from their containers.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a front perspective view of a personal item tracking system according to an embodiment of the disclosure.

FIG. 2 is a rear perspective view of an embodiment of the disclosure.

FIG. 3 is a front view of an embodiment of the disclosure.

FIG. 4 is a side view of an embodiment of the disclosure in use.

FIG. 5 is a diagram of an embodiment of the disclosure.

FIG. 6 is a perspective view of an embodiment of the disclosure.

FIG. 7 is a perspective view of an embodiment of the disclosure.

### DETAILED DESCRIPTION OF THE INVENTION

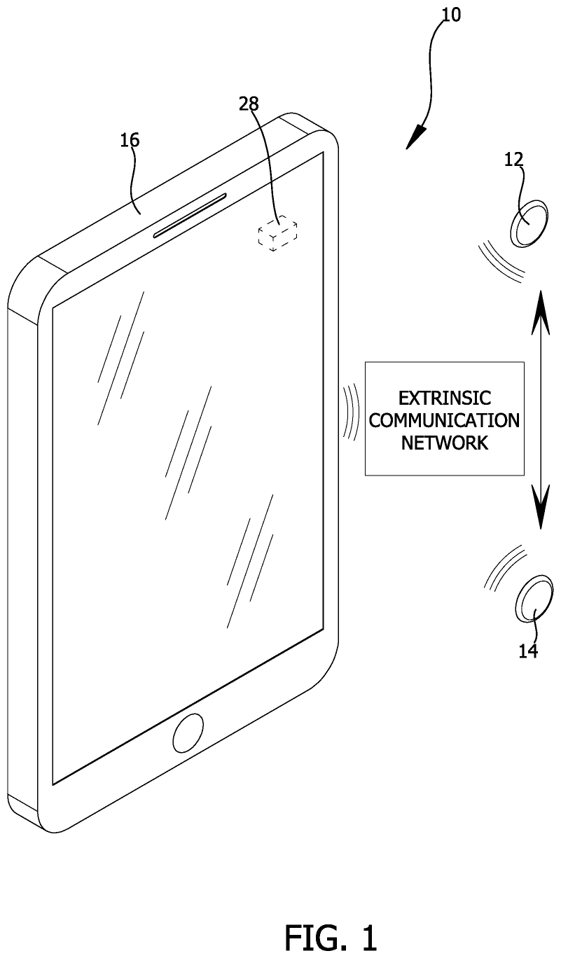

With reference now to the drawings, and in particular to FIGS. 1 through 7 thereof, a new personal item tracking system embodying the principles and concepts of an embodiment of the disclosure and generally designated by the reference numeral 10 will be described.

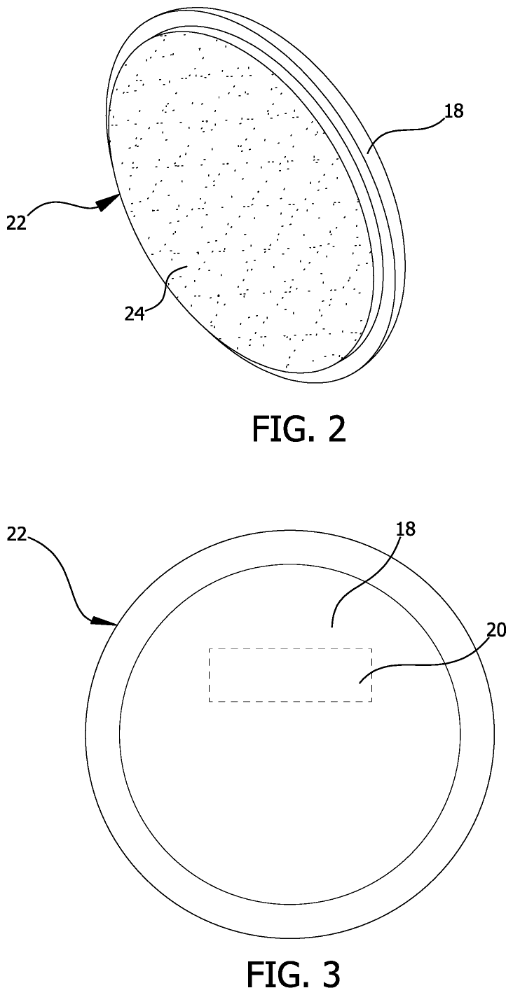

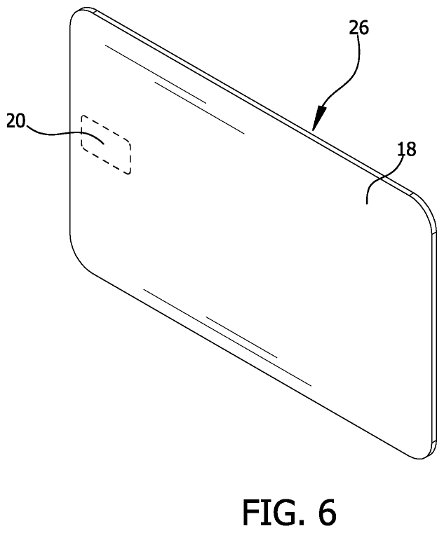

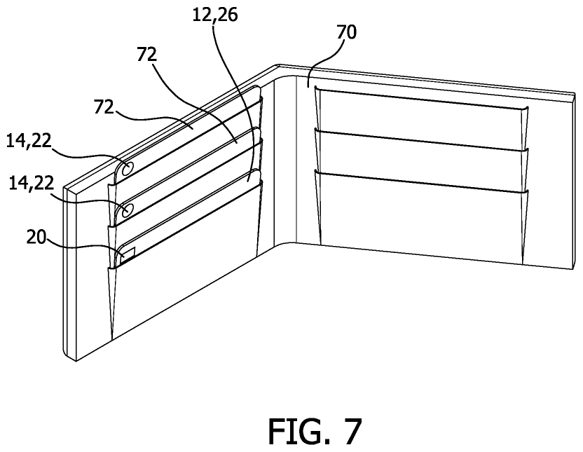

As best illustrated in FIGS. 1 through 7, the personal item tracking system 10 generally comprises a first location tracking structure 12, a second location tracking structure 14, and an electronic device 16. The first location tracking structure 12 is engageable with a container 70 for a personal item 72, such as a wallet or purse. The second location tracking structure 14 is engageable to a personal item 72, such as banking cards, identification card, or other small personal items of value that would normally be carried in a wallet or purse and are prone to loss by theft or accident. Each of the location tracking structures 12, 14 includes a body 18 and a location module 20 positioned in the body 18. The location module 20 could be any type of wireless tracking structure, such as an RFID or similar. The body 18 could be a chip 22, such as shown in FIGS. 2 and 3. The chip 22 could be attachable to a container 70 or personal item 72 in different ways, though FIG. 3 shows an adhesive layer 24 to attach the chip 22. An alternative design is shown in FIGS. 6 and 7, wherein the body 18 is in the form of a card-shaped structure 26 designed to be inserted into a card slot of a container 70 for personal items 72, such as, for example, a slot or sleeve for banking cards, identification cards, photos, or business cards that would be located in a wallet, pocketbook, or handbag. It should be understood that any suitable tracking chip 22 or structure could be used that would be appropriate for a personal item 72. For example, a very small chip 22 like an EMV chip for banking cards could be used that could be incorporated into the banking card, or a thin chip in the form of a sticker could be adhered to the personal item 72 or container 70, which thin chip would be sufficiently thin so as to not interfere with normal use of the personal item 72 or container 70.

An electronic device 16, such as a smartphone or tablet, is wirelessly connected, such as via a transceiver 28 and wireless network, to the location tracking structures 12, 14 to monitor the locations thereof. The electronic device 16 is designed to alert a user when the second location tracking structure 14 is located beyond a threshold distance 30 from the first location tracking structure 12, such as via a computer application or mobile app, to enable the user to find the personal item 72 and minimize loss thereof. The electronic device 16 is programmable to adjust the threshold distance 30, such that the user can increase or decrease the threshold distance 30. The personal item tracking system 10 can further include additional second location tracking structures 14 that are engageable to additional personal items 72. For example, as shown in FIG. 7, one container 70, such as a wallet, could contain multiple personal items 72, such as multiple banking and identification cards. The first location tracking structure 12 is in the form of the card-shaped structure 26 inserted in a slot in the wallet, though it could also be in the form of the chip 22 and attached to the wallet itself. Each of the personal items 72, such as banking and identification cards, has a second location tracking structure 14 in the form of the chip 22 attached thereto. The electronic device 16 could track the locations of each of these personal items 72 in relation to the one container 70. In this situation, the electronic device 16 is programmable to adjust the threshold distance 30 for each of the additional second location tracking structures 14 to either the same threshold distance 30 or different threshold distance 30s. In a possible embodiment, the application on the electronic device 16 can be customized or programmed to perform a variety of functions. For example, the app could be programmed to disable itself when a user is at a location, such as the home or the office, where the user might normally remove the personal items 72 and move them beyond the threshold distance 30. The app could be programmed to list names of personal items 72 that have second location tracking structures 14, so the user knows which personal item 72 is missing from the container 70. The app could be programmed for different alert levels based on the distance between the personal items 72 and the container 70, such as a warning alert that the threshold is being approached and an emergency alert when the threshold is actually crossed.

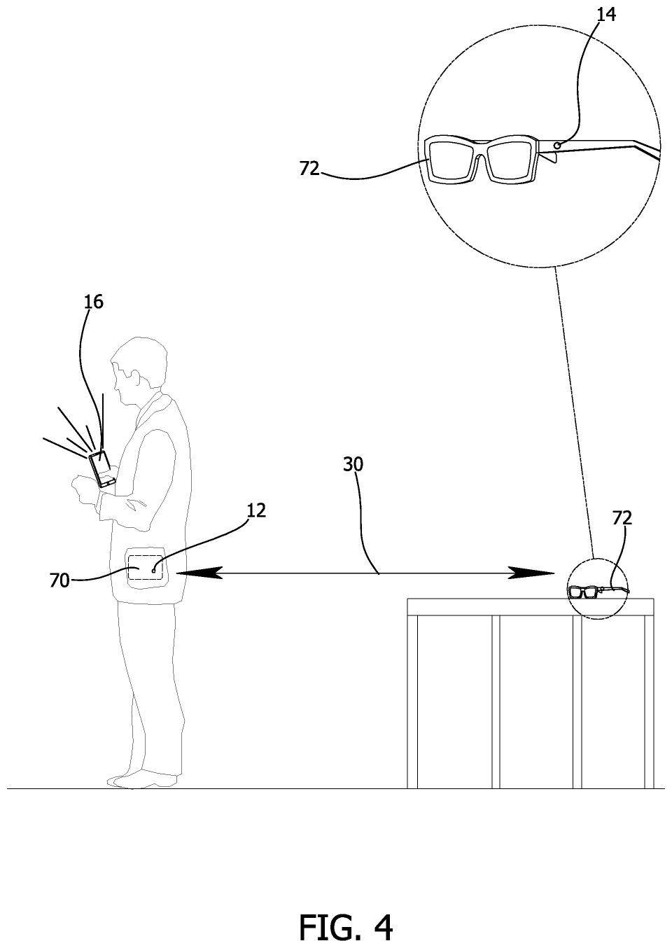

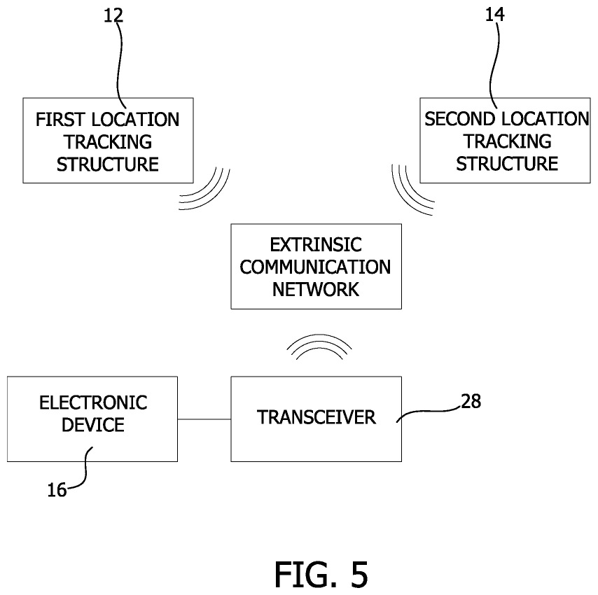

In order to use the personal item tracking system 10, the user places the first location tracking structure 12 in or on a container 70 for a personal item 72. The user also places the second location tracking structure 14 in or on a personal item 72. This step can be repeated for multiple personal items 72 that are to be stored in the container 70. The electronic device 16 is activated and wirelessly connected, as shown in the diagram in FIG. 5, to the location tracking structures 12, 14 to monitor the locations thereof. The electronic device 16 alerts the user when the second location tracking structure 14 is located beyond the threshold distance 30 from the first location tracking structure 12. Again, this could occur due to accidental loss or theft, wherein the personal item 72 is moved away from the container 70, or the container 70 is moved away from the personal item 72, or both. The user can then use location information on the electronic device 16 to find the personal item 72 and thereby minimize loss of the personal item 72. As desired, the user can adjust the threshold distance 30 by inputting a new threshold distance 30 into the electronic device 16, wherein if there are multiple second location tracking structures 14 on multiple personal items 72, the threshold distance 30 can be the same for all personal items 72 or could be customized for each personal item 72. FIG. 4 shows a possible example of the user of the personal item tracking system 10, wherein the user has placed a second location tracking structure 14 on his eyeglasses and a first location tracking structure 12 in a container 70, such as a wallet or eyeglass case. In the scenario shown, the user has left his eyeglasses behind and walked a distance away. The electronic device 16 is alerting the user that the first and second location tracking structures 14 are located beyond the threshold distance 30 relative to each other, which thereby alerts the user that his personal item 72, the eyeglasses, have possibly been left behind or stolen. The app on the electronic device 16 could not only alert him that a personal item 72 is too far away, but could also inform him that the personal item 72 is eyeglasses. The user can now retrieve his eyeglasses.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A personal item tracking system comprising:
a first location tracking structure engageable with a container for a personal item and a second location tracking structure engageable to a personal item; and
an electronic device wirelessly connected to said location tracking structures to monitor the locations thereof, wherein said electronic device is configured to alert a user when said second location tracking structure is located beyond a threshold distance from said first location tracking structure to enable the user to find the personal item and minimize loss thereof.

2. The personal item tracking system of claim 1, wherein said electronic device is programmable to adjust said threshold distance.

3. The personal item tracking system of claim 1, wherein each of said location tracking structures comprises a body and a location module disposed in said body.

4. The personal item tracking system of claim 3, wherein said body comprises a chip and an adhesive layer to attach said chip to a container for personal items or a personal item.

5. The personal item tracking system of claim 3, wherein said body comprises a card-shaped structure configured to be inserted into a card slot of a container for personal items.

6. The personal item tracking system of claim 1, wherein the personal item tracking system comprises additional second location tracking structures engageable to additional personal items.

7. The personal item tracking system of claim 6, wherein said electronic device is programmable to adjust said threshold distance for each of said additional second location tracking structures to either the same threshold distance or different threshold distances.

8. A method of using the personal item tracking system of claim 1, comprising the steps of:
placing said first location tracking structure in or on a container for a personal item;
placing said second location tracking structure in or on a personal item;
wirelessly connecting said electronic device to said location tracking structures and monitoring the locations thereof;
said electronic device alerting a user when said second location tracking structure is located beyond a threshold distance from said first location tracking structure; and
using location information on said electronic device to find the personal item and thereby minimize loss of the personal item.

9. The method of claim 8, wherein said method further comprises adjusting said threshold distance by inputting a new threshold distance into said electronic device.

10. The method of claim 9, wherein said container comprises a purse and said personal item comprises one of: a banking card, an identification card, eyeglasses, keys, and a wallet.

11. The method of claim 9, wherein said container comprises a wallet and said personal item comprises one of: a banking card and an identification card.

12. The method of claim 8, wherein the personal item tracking system comprises additional second location tracking structures engageable to additional personal items, and said method further comprises said electronic device alerting a user when any one of said additional second location tracking structures is located beyond said threshold distance from said first location tracking structure.

13. The method of claim 12, wherein said container comprises a purse and said personal items comprise at least two of: banking cards, identification cards, eyeglasses, keys, and a wallet.

14. The method of claim 12, wherein said container comprises a wallet and said personal items comprise banking cards, identification cards, or a combination thereof.

15. A personal item tracking system comprising:
a first location tracking structure engageable with a container for a personal item and a second location tracking structure engageable to a personal item; each of said location tracking structures comprises a body and a location module disposed in said body; one of (A) and (B); (A) said body comprises a chip and an adhesive layer to attach said chip to a container or personal item; (B) said body comprises a card-shaped structure configured to be inserted into a card slot of a container for personal items; and
an electronic device wirelessly connected to said location tracking structures to monitor the locations thereof; said electronic device is configured to alert a user when said second location tracking structure is located beyond a threshold distance from said first location tracking structure to enable the user to find the personal item and minimize loss thereof; said electronic device is programmable to adjust said threshold distance.

16. The personal item tracking system of claim 15, wherein the personal item tracking system comprises additional second location tracking structures engageable to additional personal items; and said electronic device is programmable to adjust said threshold distance for each of said additional second location tracking structures to either the same threshold distance or different threshold distances.
